(19) United States
(12) Patent Application Publication
(10) Pub. No.: US 2022/0180427 A1
(43) Pub. Date: Jun. 9, 2022

(54) GRAPHICAL USER INTERFACES FOR FACILITATING CHALLENGE-BASED TRANSACTIONS

(71) Applicant: Wells Fargo Bank, N.A., San Francisco, CA (US)

(72) Inventors: Christina Zikeli, Charlotte, NC (US); Gregory K. Morishige, Berkeley, CA (US)

(21) Appl. No.: 15/350,442

(22) Filed: Nov. 14, 2016

(51) Int. Cl. G06Q 40/02; G06Q 20/10; G09B 19/18

(52) U.S. Cl. CPC G06Q 40/02; G09B 19/18; G06Q 20/10

(57) ABSTRACT

A method of facilitating challenge-based transactions includes presenting an invitation to participate in a challenge that involves a resource-saving behavior on a user interface on a display device, receiving an acceptance of the invitation through the user interface of the mobile electronic device, delivering through the user interface a prompt for an indication of whether the resource-saving behavior has been achieved during a first time segment, receiving a response to the prompt, and, when the response includes an indication that the resource-saving behavior has been achieved during the first time segment, automatically initiating a predefined transaction associated with the challenge.

### TECHNICAL FIELD

This application relates generally to computing device input interfaces, and in particular to, but without limitation to graphical user interfaces for facilitating challenge-based transactions.

### BACKGROUND

Users may use graphical user interfaces (GUIs) to keep track of data such as a to-do lists, grocery lists, etc. Databases may store the data later presentation to the user. For example, users may input a number of items into a text field input element of a GUI. The items may be stored in one or more entries in the database. Upon request, an application running on a computing device may query the database for the items.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram showing an example environment for a financial health savings system.

FIG. 2 is a block diagram illustrating an example mobile computing device, within which a set of instructions, for causing the mobile computing device to perform any one or more of the methodologies discussed herein, may be executed.

FIG. 3 is a block diagram of a machine in the example form of a computer system within which a set of instructions, for causing the machine to perform any one or more of the methodologies discussed herein, may be executed.

FIG. 4 shows an example of an invitation interface that presents an invitation to participate in a challenge.

FIG. 5 shows an example account setup interface that includes an invitation to apply for a checking account or open a savings account.

FIGS. 6 and 7 show an example challenge selection interface that presents an invitation to select a challenge from a menu of available challenges.

FIG. 8 shows an example challenge configuration interface that may receive a specified daily savings amount.

FIG. 9 shows an example challenge acceptance interface.

FIG. 10 shows an example challenge prompt interface that may deliver a prompt regarding execution of a challenge.

FIG. 11 is an example challenge deferral interface that delivers a response to a challenge not being complete.

FIG. 12 shows an example dashboard interface that shows an indication that a challenge was completed on a previous day and not yet completed on a current day.

FIG. 13 shows an example dashboard interface that shown an indication that a challenge was completed on a first day, was not completed on a second day, and has not yet been completed on a third, current day.

FIG. 14 shows an example new challenge interface that may present a user who has completed a challenge with an invitation to participate in another challenge.

FIG. 15 shows an example transfer configuration interface that allows a user to specify a savings amount.

FIG. 16 shows an example transfer interface.

FIG. 17 shows an example transfer confirmation interface.

FIG. 18 shows an example congratulations interface.

FIG. 19 is a flow chart of an example method of supporting the allocation of resources for future use.

### DETAILED DESCRIPTION

Existing systems fail to provide the necessary data structures and user interfaces to solve the problem of building desired habits, such as resource-saving behavior habits, which may be tied to maintaining financial health for an individual. For example, financial health often requires a balance of near term expenditures and long term savings. With the burden of daily and monthly expenses and the natural desire to use money for discretionary spending, the act of saving may easily be deprioritized. While most people have some sense for the importance of saving money for future financial needs, many have difficulty actually doing it.

Establishment of a habitual behavior may be supported by periodic prompts to report a resource-conserving challenge, which may be tied to an automatic transaction that is dependent on a response to the prompt. In various examples described herein, an electronic system may be configured to provide a periodic prompt to provide a report on a challenge and authorize an automatic transaction, such as an electronic funds transfer, and automatically execute the transaction when the challenge is met or the transfer is authorized. By prompting a user to engage in a resource-conserving behavior and making an automatic transfer to a savings account when the behavior is confirmed, the system may support development of a desired habit.

An example electronic system may electronically challenge a user to participate in a resource-saving behavior, such as a money-saving behavior, which may eventually develop into a saving habit. When the user elects to participate in a challenge, the system may remind a user to think about building financial habits as part of his or her daily routine. For example, an example system may provide a push notification as a reminder about building the financial habit. The push notification may include a prompt to perform or report some desired money-saving activity, which may include refraining from an undesired activity (e.g. a non-budget friendly expense). The push notification may also prompt a user to log in to a financial health savings app and make a transfer to a savings account. In some examples, when a user logs in to a financial health savings application, the application may pre-fill transfer forms to make it easy and quick to transfer money to savings or authorize future transactions. Some examples may monitor and report on progress, e.g., acknowledge a particular successful execution of a challenge, or a series of success (e.g., “Congratulations, you saved on five days in a row.”)

In various examples, an electronic system can, for example, challenge a user to refrain from a particular behavior, or substitute a desired behavior in place of a less-desired behavior. Example challenges opportunities that may be supported by an electronic system include avoiding the purchase of bottled water and instead drinking free water, e.g., tap water, avoiding purchasing ready-to-drink coffee at a counter (and optionally drinking free coffee or coffee brewed at home), avoiding purchase of a meal at a restaurant (and optionally instead making a “brown bag” lunch at home at take lunch to work, or making a meal to eat at home to avoid the additional expense of purchasing food from a restaurant, taking a less expensive transportation option, e.g. biking or walking in lieu of paid transit or driving, or taking a car pool or public transportation in lieu of driving and paying to park.

The money saved by engaging in such challenges may be allocated as savings by the electronic system. For example, when a user reports successful execution of a savings challenge on a particular day, an example electronic system may transfer the savings amount—e.g., the money saved by avoiding an expense—to a savings account. The transfer may occur automatically, without further user input, when the user confirms that a savings transaction should occur, for example based on the successful achievement of a money-saving behavior as part of a savings challenge. In some examples, sensors on a computing device may be used to determine if the challenge was met. In some examples, a GPS sensor on a computing device reports a geographic position of a user, or a series of geographic positions, and a processor on the device analyzes the data from the GPS sensor and determines whether a user avoided a particular establishment, such as a coffee shop or other physical location that is related to completion of a challenge, such as refraining from buying coffee. In some examples, the processor determines from sensor data whether a user visited an establishment related to completion of a challenge, such as a train station, park and ride facility, bike path, walking route to assess whether a transportation challenge has been met. In some examples, a series of geographic locations are received from a sensor on the device and analyzed to determine a mode of transportation from location, movement pattern, or velocity. In some examples, sensors of a device provide information to a processor on the device, and the processor determines a query from the sensor data, such as inquiring whether a desired activity such as biking to work was completed. In some examples, a processor receives information from a computing device and infers from such information that an establishment such as a coffee shop was visited, and the device queries the user regarding completion of a challenge while the user is at the location or within a specified time, e.g. 10 minutes, after the user visits the establishment. For example, the computing device may detect from sensor data that a user is approaching, is at, or recently visited a coffee shop, and query whether the user successfully avoided a transaction at the establishment, such as a food or beverage purchase.

An example electronic system may help a user build a habit of savings by inviting the user to participate in a challenge to consistently exhibit healthy financial behavior, e.g., a take a budget-friendly mode of transportation to work, in a plurality of time segments, such as once a day for a specified number of days. In various examples, the system may track and report progress for review by the user, such as by presenting a chart or other graphic that shows the days on which the challenge was successfully met. For a ten-day challenge, each day in which the challenge is met may be marked with a checkmark, and each day in which the challenge is not met may be marked with a different symbol, such as an X. Such reporting system may recognize a user's success in meeting the challenge, and provide a disincentive for failure (e.g., by displaying an X corresponding to a missed day).

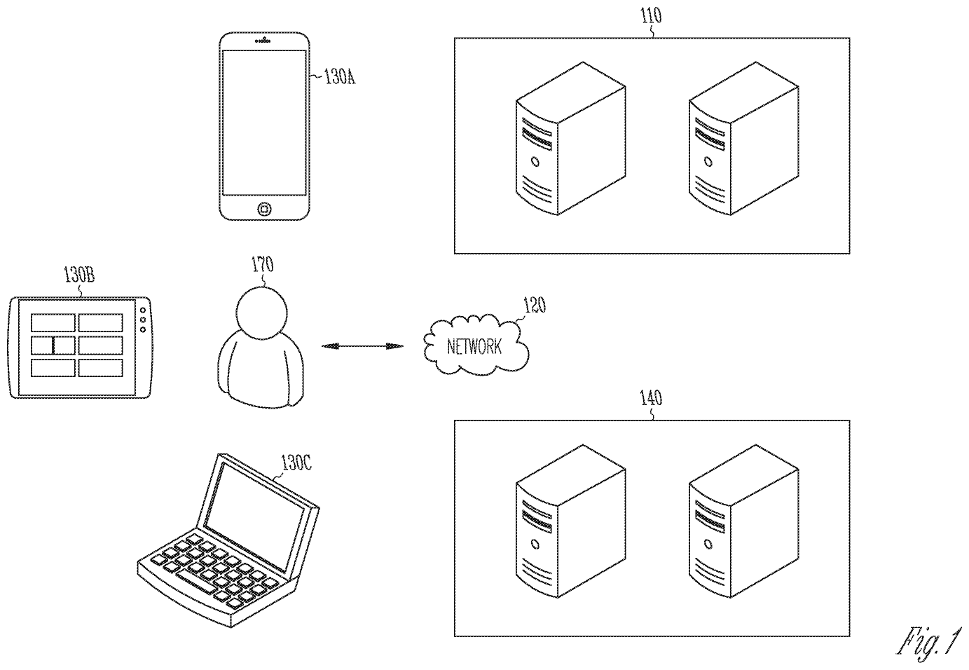

FIG. 1 is a diagram showing an example of an environment for a financial health savings system. A financial health saving server 110 may communicate through a network 120 with a mobile electronic device such as a mobile phone 130a, tablet 130b, or mobile laptop or other computer 130c. The financial health saving server 110 may also communicate with a financial services system 140. In some examples, the financial health saving server 100 may reside on or with the financial services system 140. A user 170 may interact with one of the mobile electronic devices 130a, 130b, 130c to send an instruction to the financial health saving server 110, such as an instruction to the financial services system to transfer money to a savings account.

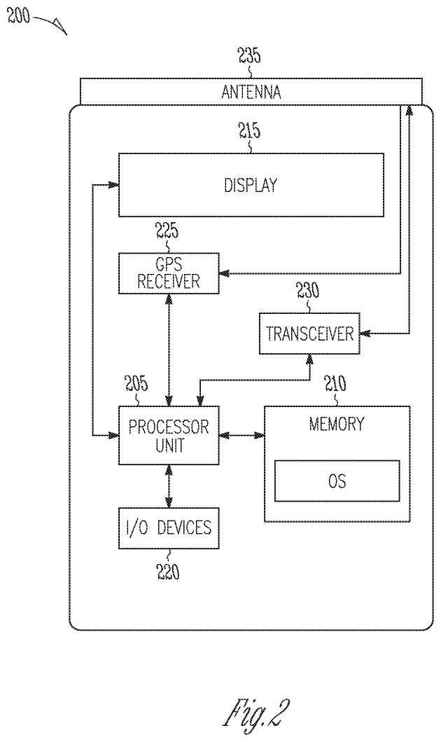

FIG. 2 is a block diagram illustrating an example mobile electronic device 200. The example mobile electronic device 200 may include a processor unit 205 and a memory 210. The memory may store information that includes an operating system such as Android™ or iOS™, or Windows Mobile™, application programs, such as a financial health savings application including instructions for executing a financial health savings method to challenge a user to save money, and application data, that may include for example information about the accomplishment of a challenge or instructions for transferring money to a savings account. The processor 205 may deliver data to the memory 210 and retrieve information from the memory 210. The processor may also send output to a display 215. Where the display 215 includes sensors, e.g., the display 215 is a touch-screen display, the processor may also receive input from the display. The processor may also send output and receive input through an input-output interface 220 such as a USB™ or Apple™ Lightning™ connector. The processor may also receive information from a GPS receiver 225, which can, for example, deliver location coordinates of the device, or a clock (not shown), which may be set by a user, or automatically set by reference to an external resource. The processor 205 may also communicate through a transceiver 230 to send wireless information through an antenna 235 using cellular, Bluetooth™, Wi-Fi, or other wireless communication protocols. The example device may also include other features (not shown) such as a speaker, camera, accelerometer, and other sensors.

In an example, the mobile electronic device 200 may be a handheld device that has a touch-screen interface, such as a mobile phone. In other examples, the mobile electronic device 200 may be a tablet, a virtual reality headset, such as goggles or glasses, a component of an automobile, such as a touch screen display or heads-up display.

FIG. 3 is a block diagram of an example machine in the form of a computer system 300, within which a set or sequence of instructions may be executed to cause the machine to perform any one of the methodologies discussed herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The machine may be configured as a mobile device.

Example computer system 300 includes at least one processor 302 (e.g., a central processing unit (CPU), a graphics processing unit (GPU) or both, processor cores, compute nodes, etc.), a main memory 304 and a static memory 306, which communicate with each other via a link 308 (e.g., bus or interconnect). The computer system may also include a clock (not shown.) The computer system 300 may further include a video display unit 310, an input device 312 (e.g., an alphanumeric keyboard), and a user interface (UI) navigation device 314 (e.g., a mouse). In one embodiment, the video display unit 310, input device 312 and UI navigation device 314 are incorporated into a touch screen display. The computer system 300 may additionally include a storage device 316 (e.g., a drive unit), a signal generation device 318 (e.g., a speaker), a network interface device 320, and one or more sensors (not shown), such as a global positioning system (GPS) sensor, compass, accelerometer, location sensor, or other sensor.

The storage device 316 includes a machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computer system 300, with the main memory 304, static memory 306, and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions 324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 324 may further be transmitted or received over a communications network 330 using a transmission medium via the network interface device 320 utilizing any one of a number of well-known transfer protocols (e.g., HTTP). The communications with the communication network 800 optionally may occur using wireless transmissions sent via one or more antennas 328. Examples of communication networks include a local area network (LAN), a wide area network (WAN), the Internet, mobile telephone networks, plain old telephone (POTS) networks, and wireless data networks (e.g., Wi-Fi, 10, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

A financial health savings application may be embodied as an application (i.e. “app” or mobile app) on the mobile electronic device 200. In an example where the device 200 includes a touch screen, input may be received through specified areas on the touch screen—referred to herein as electronic “buttons”—that are associated with a specified input. Various other types of selectable input techniques may be substituted for the buttons. For simplicity, the methods and system described herein will be described in the context of buttons.

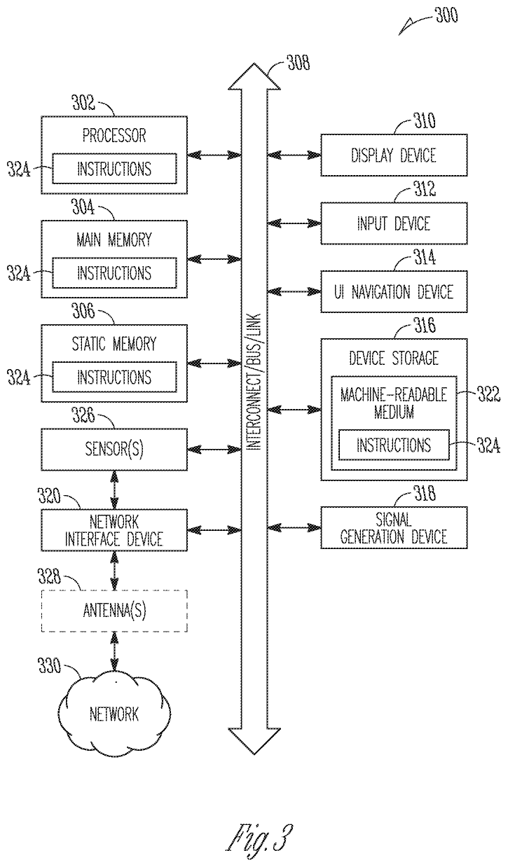

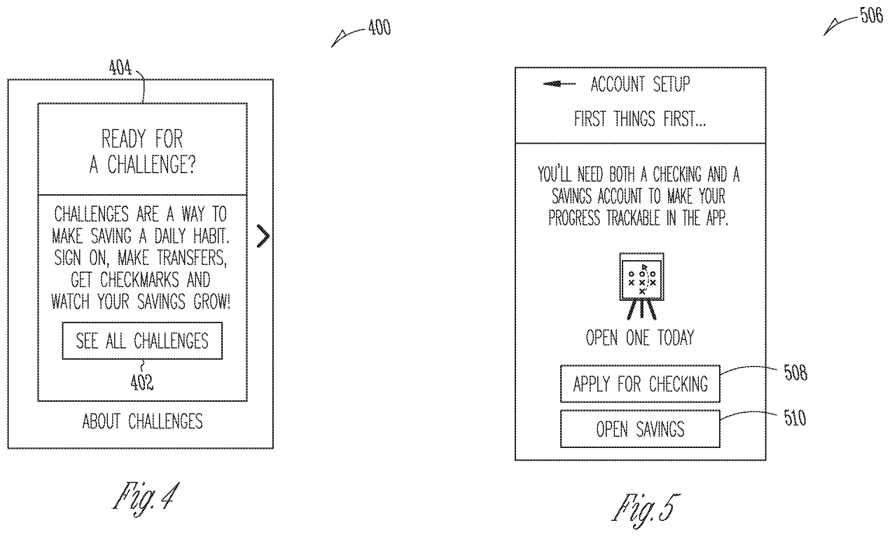

An example financial health savings system can, for example, deliver an invitation to participate in a challenge that involves resource-saving behavior, such as saving money by avoiding or reducing certain expenses. The system may deliver the invitation by displaying on an invitation interface a message that offers the opportunity to participate in a challenge. FIG. 4 shows an example invitation interface 400 that presents an invitation to participate in a challenge. The invitation interface may be presented, for example, through a touch screen, such a touch screen as on the mobile device 200. Input may be received through touch screen display 215 or input/output interface 200 and processed by the processor 205, which may trigger presentation of other interfaces on the display 215 in response to input, and convey information such as savings transfer requests to a financial health saving server 110, or directly to a financial services system 140.

In an example, the invitation interface 400 may receive input from a user via selection of a first button 402 (“See All Challenges”) to see information about available challenges, or a second button 404 (“About Challenges”) to learn more about participation in a challenge through the system.

In an example system, at least two accounts are required to participate in a challenge, to enable the user to transfer money from one account, such as a checking account, to another account, which may be a savings account. When the invitation interface receives a selection of the first button 402 (“See All Challenges”) in FIG. 4 and the user does not have a requisite account, the account setup interface 506 may be presented. In an example configuration, the system may display on an account setup interface 506 a statement explaining the need for both accounts. The account setup interface 506 may also receive input from a user via selection of a third button 508 to apply for a checking account, or through a fourth button 510 to open a savings account, which may require input of additional information on subsequent screens.

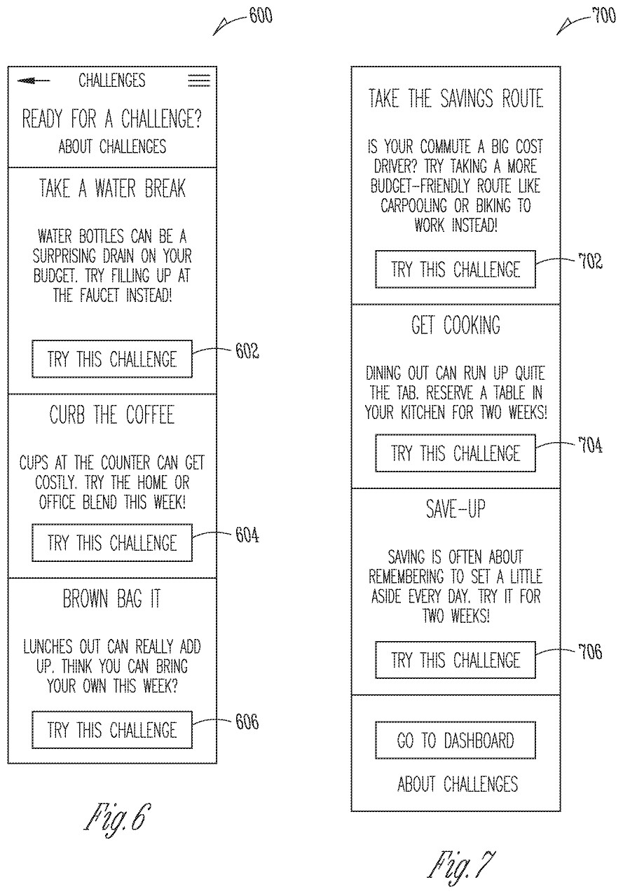

When the invitation interface receives a selection of the first button 302 (“See All Challenges”) in FIG. 4, a challenge selection interface may be presented. FIGS. 6 and 7 show an example challenge selection interface 312 that presents an invitation to select a challenge from a menu of available challenges. The challenges in FIGS. 6 and 7 may be connected, so that the challenge selection interface 600 may scroll from the challenges shown in FIG. 6 to the challenges shown in FIG. 7, i.e. the bottom of FIG. 6 may be connected to the top of FIG. 6 to create a continuous menu of challenge options.

The challenge selection interface 600 may receive input in the form of selection of a button on a touch screen interface. Selection of a first challenge button 602 on the challenge selection interface 600 may indicate a selection of a first challenge (“Take a water break”) to save money by avoiding the purchase of bottled water, for example by using tap water. Selection of a second challenge button 604 may indicate a selection of a second challenge (“Curb the Coffee”) to save money by avoiding purchase of coffee at a counter or coffee shop, and optionally coffee brewed at home or other budget-friendly sources of coffee. Selection of button 606 may indicate a selection of a third challenge (“Brown Bag It”) to save money by avoiding the purchase of a meal at a restaurant, and optionally make a “brown bag” lunch at home to take to work. Selection of button 702 (shown on the challenge selection interface 700 in FIG. 7) may indicate a selection of a fourth challenge 702 (“Take the Savings Route”) to save money by taking a less expensive transportation option, e.g. biking or walking in lieu of paid transit or driving, or taking a car pool or public transportation in lieu of driving and paying to park. Selection of a fifth button 322 may indicate selection of a fifth challenge 704 (“Get Cooking”) to save money by making a meal to eat at home to avoid the additional expense of purchasing food from a restaurant. Selection of a sixth button 706 may indicate a selection of a sixth challenge (“Save-Up”) to remember to save money every day.

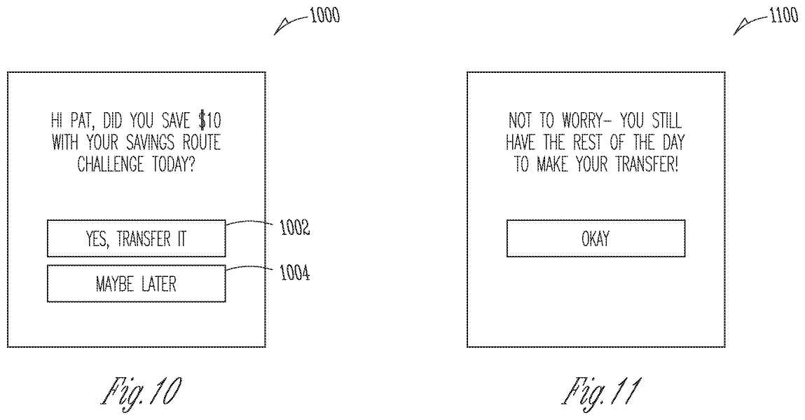

The savings challenges may be time-bound, and may be configured to periodically prompt a user to report or engage in behavior related to the challenge. For example, the savings challenge may extend for a challenge period of a specified duration, such as one week, ten days, two weeks, or a month. A savings challenge prompt to a user, such as presentation of the prompt interface shown in FIG. 10, may occur periodically during the challenge period, such as once a day, every other day, once or multiple times a week, or multiple times a day, such as twice a day (e.g., morning and evening commute), thrice a day (e.g. each of three meals). A challenge that requires an execution of desired savings behavior at least once a day may be desirable to build habitual behavior that may persist beyond the duration of the challenge.

The prompt can, for example, be scheduled to occur at a specified time of day, or multiple times per day, to provide accountability around the time the challenge behavior occurs. For example, a prompt to avoid incurring a restaurant lunch expense may be presented before a lunch period, or after a lunch period. Scheduling a prompt before an activity is likely to occur can act as a reminder of the challenge to engage in money-saving behavior. Scheduling a prompt after an activity is likely to occur can provide timely accountability for reporting success or failure in achieving the challenge. In another example, the prompt may occur around the time of a morning commute, and around the time of an evening commute. The prompt can also be scheduled to occur at a time that a preparatory activity is required. For example, a prompt relating to a brown bag lunch may occur the morning to remind a user to, for example, make a lunch for consumption later in the day. In another example, such a prompt is presented the evening before the money-saving brown-bag lunch, to allow the user to prepare for successful savings activity the next day.

In some examples, a user may elect to take a break or a day off, which may, for example, be communicated or configured through an input into the electronic system, through a response to a prompt, or through a user setting. For example, a user may be permitted a reprieve from a challenge on their birthday. In another example, a user may “earn” a day off after a specified number of days of successful execution of a challenge (e.g., 30 days.) In some examples, a prompt is configured to occur only on certain days or correlated to certain events. For example, a savings challenge that relates to transportation to work may prompt a user only on days that a work commute is known to occur, such as on Monday through Friday, or on a configured work schedule.

In some examples, multiple challenges may run simultaneously, or a single challenge may involve multiple types of challenge behaviors. For example, challenges can be blended together to assure at least one daily prompt to participate in at least one of the savings challenge. For example, a user may be prompted to participate in a transportation-related challenge on work days and a food challenge (e.g. avoid restaurant expense) or entertainment expense challenge on weekends. In some examples, a single challenge may involve different challenge prompts that are relevant for a particular day, such as a food challenge to pack a lunch during the week to avoid restaurant expense, and making a lunch at home on the weekend, again to avoid restaurant, or takeout, expense.

In some examples, location information, such as location information obtained from a mobile device, may be used to inform the timing of delivery of a prompt. For example, a prompt may be delivered when a user is determined from location information to be at home, leaving home, leaving a work place (e.g. to go to lunch or commute home), or at an establishment (e.g. near restaurant.) In some examples, information from a user profile may be used to determine when to deliver a prompt. A user profile may include, for example, user schedule information (e.g. time of commute or time of meals, or days that the user works or does not work), location information (e.g. workplace or home address), or personal preferences (e.g. restaurant preferences or transportation options.) In some examples, a combination of time, location, activity, or user profile information is used together to determine when to deliver a savings prompt.

An automatic transaction may be triggered in response to a report that a challenge task has been successfully achieved. In an example, an amount of money saved by engaging in such challenges, such as a reduced or avoided expense, may be allocated as savings by the electronic system. For example, when a user reports successful execution of a savings challenge on a particular day, the savings amount—such as the money saved by avoiding an expense—may be automatically transferred to a savings account from a checking account or other account. In an example, the savings amount that is automatically transferred is a consistent specified amount throughout the challenge, such as five dollars a day in reduced transportation expense, or fifteen dollars a day in reduced food expense. In some examples, the savings amount is reported by a user at the time of a transaction, or deduced from financial data such as electronic transaction data.

When a particular challenge, such as the “Savings Route Challenge 702, is selected through the challenge selection interface, a challenge configuration interface 800 may be presented on the user interface, as shown in FIG. 8. Achievements of an element of the selected challenge may be tied to an automatic transaction, which may be a financial transaction. FIG. 8 shows an example challenge configuration interface 800 that may receive a specified daily savings amount. The challenge configuration interface 800 may indicate that the challenge has a specified duration 802, e.g., 14 days. The challenge configuration interface 800 may enable specification of a daily savings amount 806 through the interface. Selection of a decrease button 808 may decrease the daily savings amount, e.g. by one dollar from $10 to $9. Selection of an increase button 810 may increase the daily savings amount, e.g. from $10 to $11. In an example, the total potential savings 804 may be automatically updated to reflect the daily savings amount and the specified duration and number or periods in the duration. In the example shown, the duration and periodicity (e.g. daily) of the challenge is not configurable. In some examples, the duration or periodicity of the challenge may be configurable through selection of periodicity decrease and increase buttons (e.g. to adjust hours or days in a discrete challenge period). In other examples, the savings amount, duration, and periodicity may be adjusted through other interface mechanisms such as sliders, graphs, or pull-down selection menus. The challenge interface 800 may indicate a total potential savings 804 that is based on the savings amount and the duration and periodicity of the challenge (e.g. save $10 a day for 14 days→$10×140=$140.) When the configuration is complete, the configuration interface 800 may receive an indication of acceptance of a challenge through acceptance button 812, or cancellation of the challenge selection through cancellation button 814.

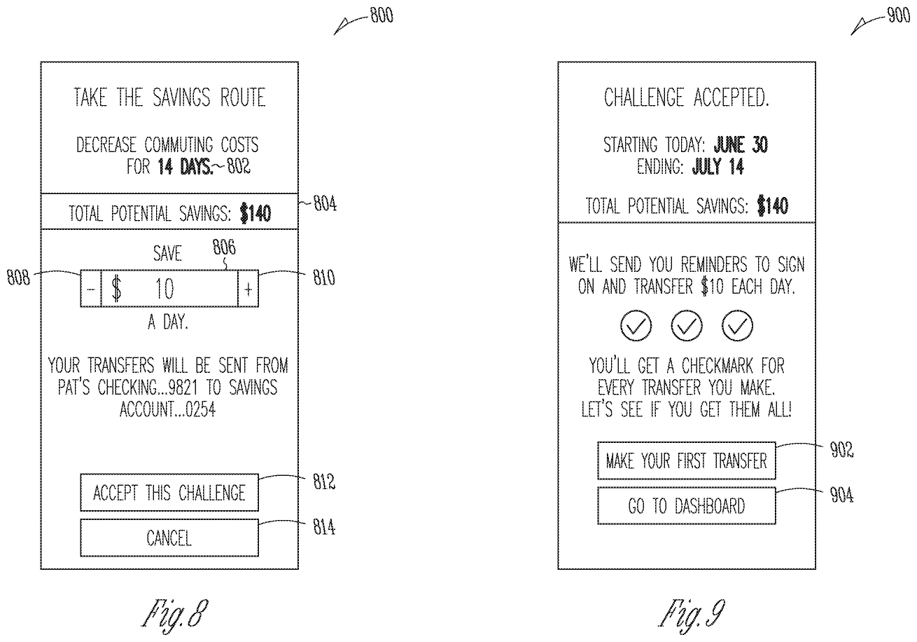

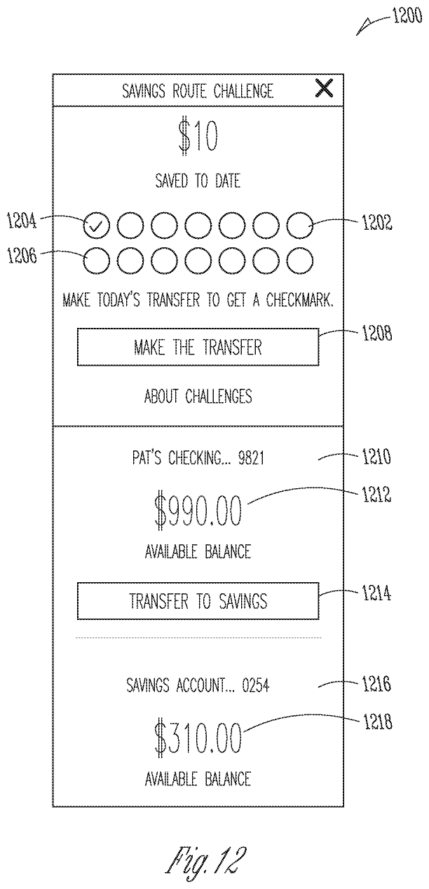

When a challenge is accepted, for example through the challenge acceptance button 812 shown in FIG. 8, a challenge accepted interface 900 may be presented. FIG. 9 shows an example challenge accepted interface 900. The challenge accepted interface 900 may state challenge information, such as starting date and ending date of the challenge period (e.g. June 30 to July 14), the daily savings amount (e.g., $10), and the total potential savings amount ($140) if the challenge is met for all challenge days. The challenge accepted interface 900 may include a first transfer button 902, the selection of which may trigger immediate or delayed transfer of funds (e.g., $10) to a savings account. The challenge accepted interface 902 may also include a dashboard button 904 that may trigger the presentation of a dashboard interface, such as the interface shown in FIG. 12.

During the challenge period, a prompt interface may be presented to remind the user about the challenge activity. The prompt interface may be presented daily, for example. Various other periodic prompt schedules such as weekly or multiple times a day are possible, as discussed above. The prompt interface can serve as a reminder to a user about the commitment to participate in the challenge, and the need to engage in a particular activity to comply with the challenge in a particular time window, such as a day. An example prompt interface 1000 is shown in FIG. 10. The prompt interface 1000 can, for example, be associated with a push notification to trigger review of the prompt interface by a user. The prompt interface 1000 may include a challenge executed button 1002 that may indicate that a challenge has been completed, which may trigger transfer of a savings amount. The prompt interface may also include a defer button 1004 that may defer the transfer and optionally trigger a later repeated presentation of the prompt interface 1000 on the same day, such as through a second push notification. Selection of the defer button 1002 may trigger presentation of a challenge deferral interface. FIG. 11 shows an example challenge deferral interface 1100 that delivers a response to a challenge not being complete, such as encouragement to complete the challenge on that day.

Selection of the challenge executed button 1004 may trigger immediate or deferred transfer of the savings amount, e.g. by the processor 205 causing the device 200 shown in FIG. 2 to send a message through the transceiver 230 and to the antenna 235 and through a network 120 (shown in FIG. 1) to financial health server or a financial services system 140. In some examples, selection of the challenge executed button 1002 may trigger presentation of a dashboard interface, from which a transfer may be triggered as described above.

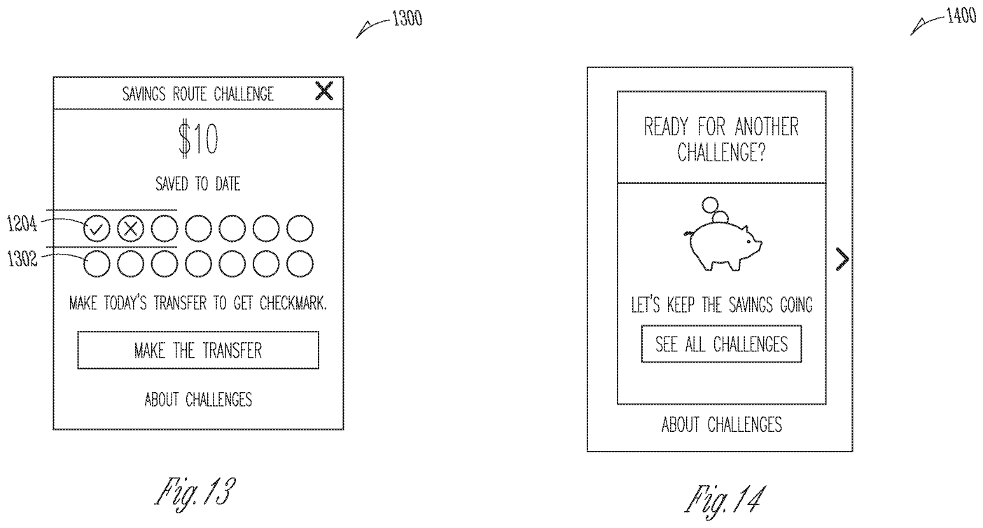

FIG. 12 shows an example dashboard interface 1200. The dashboard interface 1200 may include a progress report section 1202 that conveys whether the challenge was executed on a series of discrete challenge periods (e.g., days) that together form the full challenge period (e.g., two weeks). In the example shown in FIG. 12, a check mark 1204 indicates that the challenge was successfully met on day 1. An empty circle 1206 may indicate that the challenge has not yet been met on day two. FIG. 13 shows an example dashboard interface in which the progress report section 1202 indicates that the challenge was not met on day 2, as indicated by an indicium 1302—in this case an X—in the circle for day 2.

Returning to FIG. 12, the dashboard interface 1200 may also include a report 1216 about the balance 1218 of a savings account, and a report 1210 on the balance 1212 of a source account, such as a checking account. The source balance report 1210 may enable verification of funds prior to initiation of a transfer to savings. Selection of a transfer button 1214 (“Transfer to Savings”) may initiate a funds transfer from the source account (e.g., checking account) to the savings account. In an example, selection of a transfer selection button 1208 proximate the report section may open or launch the balance report interface section 1210 that includes the savings balance report 1216 and source balance report 1210. In another example, the dashboard interface may be scrollable to access the balance report interface section 366.

When a challenge is complete—for example when all the days in a challenge period have passed, a new challenge interface may be presented. FIG. 14 shows an example new challenge interface 1400 that may present a user who has completed a challenge with an invitation to participate in another challenge.

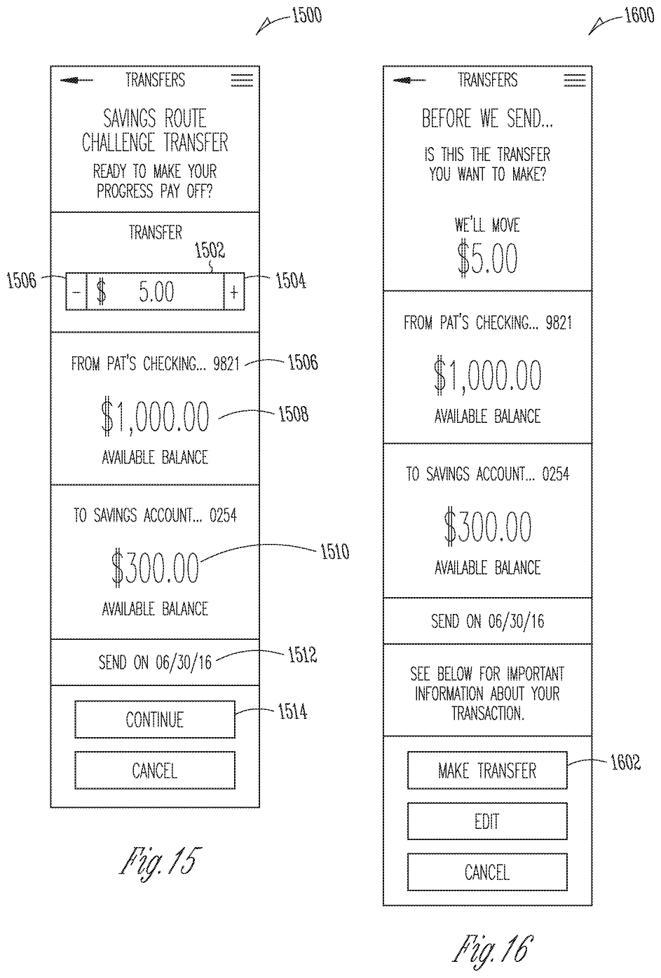

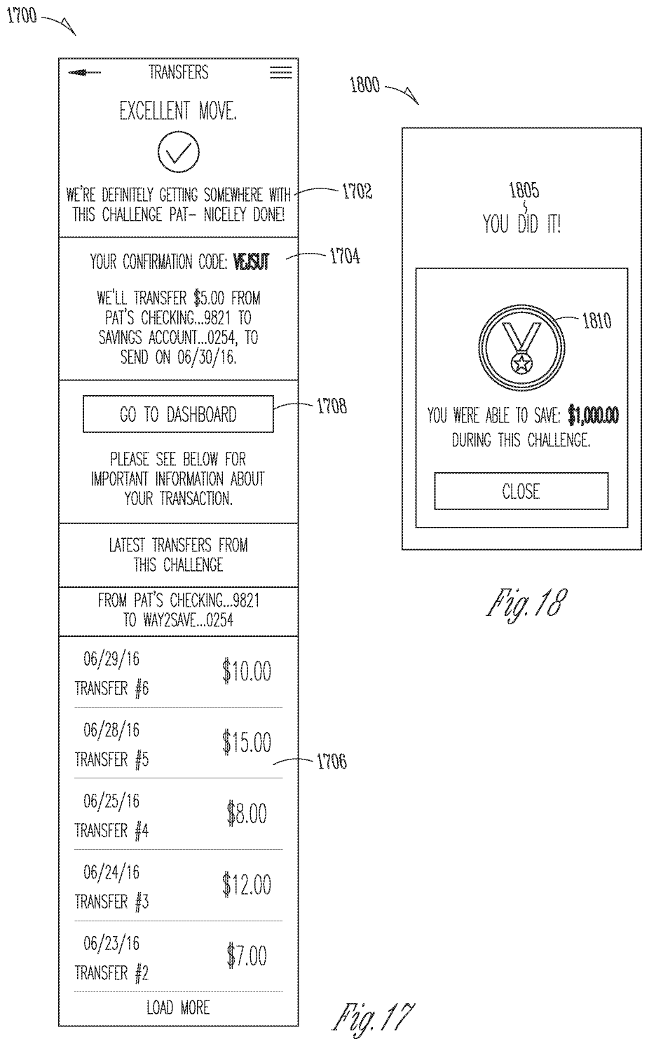

In some examples, a savings amount may be specified on a periodic (e.g., daily) basis, as opposed to being a fixed amount that it repeated throughout the challenge period. FIG. 15 shows an example transfer configuration interface 1500 that allows a user to specify a savings amount 1502. Selection of an increase transfer amount button 1504 may increase the savings amount 1502 by an incremental amount (e.g. a cent, a dollar or five dollars) and may optionally be configured to increase the amount more quickly if the button is held down. Selection of a decrease transfer amount button 1506 may decrease the savings amount 1502 by an incremental amount. As previously described, a balance report section 1506 may provide a balance report 1508 for a source account and for a destination account 1510, which may be a savings account. A date field 1512 may be automatically set for the present date, or may be configurable to specify a future date. Selection of a continue button 1514 may cause the interface to proceed to a transfer interface. FIG. 16 shows an example transfer execution interface 1600. The transfer execution interface 1600 may include a savings transfer button 1602 that may initiate a transfer to savings. After the transfer is initiated, a transfer confirmation interface may be presented. FIG. 17 shows an example transfer confirmation interface 1700. The transfer confirmation interface 1700 may include a congratulatory message 1702, a confirmation code 1724, a list of recent transfers from the challenge 1706, and a dashboard button 1708 that when selected may present the dashboard interface 1200 again.

In an example, the transfer configuration interface 1500, transfer execution interface 1600, and transfer confirmation interface 1700 may be presented as part of a challenge to remember to save money every day, e.g., in response to selection of the button 706 (“Save-Up”) shown in FIG. 700 and the subsequent acceptance of the challenge. In other examples, the transfer configuration interface 1500, transfer execution interface 1600, and transfer confirmation interface 1700 may be presented as part of a challenge to exhibit budget-friendly behavior, such as one of the other challenge examples (Take a Water Break, Curb the Coffee, etc.) shown in FIGS. 6 and 7 to enable for daily reporting on an actual or estimated amount of money saved.

FIG. 18 shows an example congratulations interface 1800. The congratulations interface 1800 may be presented when a user successful completes a challenge. The congratulations interface 1800 may include a congratulatory note (e.g., “You did it!”). The congratulations interface 1800 may additionally or alternatively include a badge 1810. The badge may be animated to draw attention to the badge and recognize the user for the successful completion of the challenge. In some examples, the badge 1810 is presented with an accompanying sound (e.g. “Hooray” or cheering or a music or other fanfare, or a combination thereof.)

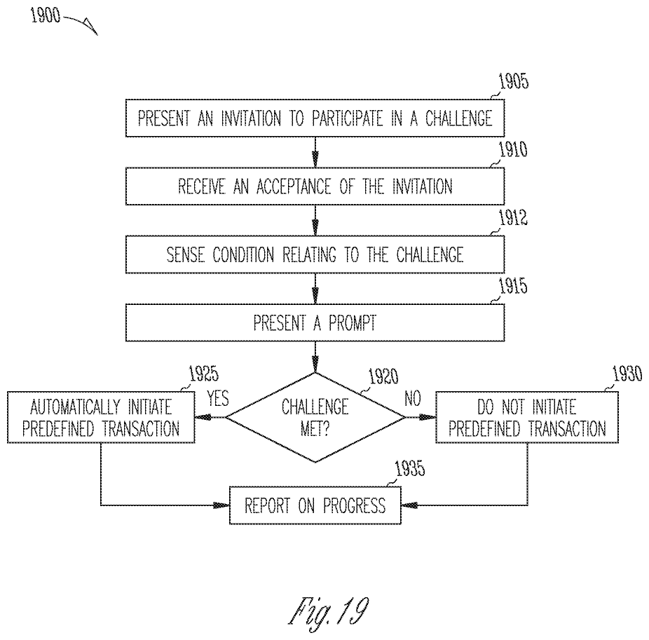

FIG. 19 is a flow chart illustrating an example method 1900 that can include automatically initiating a transaction in response to achievement of a challenge. The method may be implemented, for example, as an application running on a mobile electronic device (i.e. as a mobile app.) In some examples, money saved by engaging in challenges may be allocated as savings. For example, when a user reports successful execution of a savings challenge on a particular day, an example electronic system may transfer the savings amount—the money saved by avoiding an expense—to a savings account.

At 1905, an invitation may be presented to participate in a challenge. The invitation may be delivered, for example, through a user interface of an electronic device, such as in the form of the invitation interface 200 shown in FIG. 4. The challenge may involve a resource-saving behavior. The challenge may be a time-bound challenge to consistently engage in a budget-friendly activity over a number of time segments, such as a number of days. The challenge can, for example, include a challenge to save money by engaging in budget-friendly behavior, or avoiding a non-budget friendly behavior, or a challenge to save money by transferring money on a periodic basis (e.g., daily) from a source account (e.g., a checking account) to a destination account (e.g., a savings account), or a combination of both, where less-costly options are implement and the cost savings are transferred into a savings account.

Example challenges may include avoiding the purchase of bottled water and instead drinking free water, e.g., tap water, avoiding purchasing ready-to-drink coffee at a counter (and optionally drinking free coffee or coffee brewed at home), avoiding purchase of a meal at a restaurant (and optionally instead making a “brown bag” lunch at home at take lunch to work, or making a meal to eat at home to avoid the additional expense of purchasing food from a restaurant, taking a less expensive transportation option, e.g. biking or walking in lieu of paid transit or driving, or taking a car pool or public transportation in lieu of driving and paying to park. In an example, the invitation can include presenting a plurality of challenges, such as the challenge examples above, and enabling a user to select a particular challenge.

At 1910, an acceptance of the invitation may be received. The acceptance may be received through the electronic device on which the interface is presented, for example through a user selection of an acceptance button or other control.

At 1912, a condition relating to the challenge may be received. The condition may be sensed, for example, by a global positioning system (GPS) sensor, compass, accelerometer, location sensor, or other sensor, or operational state of an application (“app”) on a mobile device (e.g. activity of an app that is configured to facilitate or consummate a purchase.) In some examples, a geographic location (e.g., using GPS), velocity or stationary state (e.g. using GPS or an accelerometer or both), proximity to a wireless network, other presence, or engagement in an activity (e.g. app purchase activity or other purchase environment) is sensed by a mobile device. In some examples, the method may progress to step 1915 without sensing or attempting to sense a condition (e.g., step 1912 may be skipped or optional), or a device may attempt to sense a condition and proceed to step 1915 even if the condition is not sensed.

At 1915, a prompt is presented. The prompt may be delivered to and presented on a user interface to obtain an indication from a user of whether to transfer a savings amount. The prompt can include a reminder to a user to participate in an activity related to the challenge, or a reminder or invitation to report participation in the activity. In an example, the prompt can include options to report that a money-saving behavior was achieved, or not achieved, during a time segment.

By delivering a timely prompt, a user may be supported in a making a choice that complies with a challenge, which over time may lead to the challenge behavior developing into a habit which may persist beyond the end of the challenge. In an example, if a user has accepted a challenge to engage in a saving behavior, such as refraining from buying coffee from a coffee shop that day, the prompt may inquire whether saving behavior was exhibited, which may indicate whether the savings amount should be transferred. In another example, the prompt may simply provide the user with an opportunity to choose transfer money to savings as a matter of choice, such as described above with respect to the “Save-Up” challenge shown in FIG. 7. The prompt can, for example, be scheduled to occur at a specified time of day, or multiple times per day, to provide accountability around the time the challenge behavior occurs. For example, a prompt to avoid incurring a restaurant lunch expense may be presented before a lunch period, or after a lunch period. In another example, the prompt may occur around the time of a morning commute, and around the time of an evening commute. The prompt can also be scheduled to occur at a time that a preparatory activity is required. For example, a prompt relating to a brown bag lunch may occur the morning to remind a user to, for example, make a lunch for consumption later in the day. In another example, such a prompt is presented the evening before, to allow the user to prepare for successful savings activity the next day. In some examples, location information, such as location information obtained from a mobile device, may be used to inform the timing of delivery of a prompt. For example, a prompt may be delivered when a user is determined from location information to be at home, leaving home, leaving a work place (e.g. to go to lunch or commute home), or at an establishment (e.g. near restaurant.) In some examples, information from a user profile may be used to determine when to deliver a prompt. A user profile may include, for example, user schedule information (e.g. time of commute or time of meals, or days that the user works or does not work), location information (e.g. workplace or home address), or personal preferences (e.g. restaurant preferences or transportation options.) In some examples, a combination of time, location, activity, or user profile information is used together to determine when to deliver a savings prompt. In some examples, a prompt can be delivered when a device determines that a condition, such as a sensed location, a sensed movement of the device (e.g. direction or velocity), a sensed activity e.g. as detected by an accelerometer, camera, or microphone, or, sensed proximity to other devices or people, and presents the prompt when a specified condition is present, or the specified condition was recently present. In some examples, the specified condition is determined based on a combination of sensed parameters. In some examples, the specified condition is determined based on a single parameter, such as location. In some examples, the specified condition may be physical presence at a location, or a recent departure from a location, or the progress toward or anticipated arrival at a location. In some examples, the location can be sensed using a GPS circuit in an electronic device. In some examples, the location can be detected based upon connection to a particular wireless network.

At 1920, a response to the prompt is received. The response may be evaluated to ascertain whether to transfer a savings amount. If the challenge has been met, a transaction 1925 is automatically initiated. In some examples, the transaction can be a transfer of a savings amount. If the challenge has not been met, at 1930 the transaction is not initiated. In some examples, the response may include a deferral of the challenge, or an exemption from the challenge, such as use of an earned or granted “free day” in which compliance with the challenge is not required, or exemption on a “savings holiday” such as the user's birthday. In some examples, the method may include repeating delivery of the prompt and receiving a response to give a user another opportunity to achieve a money-saving behavior, or to assure that the response is received after the money-saving behavior is completed or assured.

At 1935, progress on the challenge is optionally reported, for example through a dashboard interface, such as the dashboard interface 1200 shown in FIG. 12. In an example, a mobile device may record successful completion of the challenge as data stored in a memory circuit on the mobile device, and the mobile device may access the memory circuit to retrieve the data, which may be processed to generate a report is presented on the dashboard interface. In another example, the system communicates with a server that accesses a database where progress information is stored, retrieves the information, and processes the information to generate a report through the dashboard interface. In some examples, information from both a database and a mobile device may be used to generate the dashboard interface. The method may optionally return to step 1915 again that day to provide the user with another attempt at meeting the challenge. An example financial health savings system may provide a report of such success through a response to a prompt, or through input from a user who is deliberately accessing a financial health savings system, such as through a financial savings application on a mobile device. In various example, the progress may be reported on a dashboard interface on a mobile device where the prompts are presented, or on a difference device such as a home computer, or on another mobile device. In an example, the progress can be shared with other users through a social networking application, or through a dedicated application that allows other users to view and track progress.

The method steps 1915 through 1935 may be repeated periodically for a plurality of time segments during a challenge time period, e.g., at least once a day for a specified number of days (e.g. seven days), and each the progress during each time segment (e.g. success or failure for each day) may be reported on a dashboard to enable review of the user's progress. In an example, information stored in a memory in a mobile device is retrieved and processed each day to develop a report that is presented on the dashboard. In another example, information stored in a database may be accessed through a server and processed by a back-end system or by the mobile device to develop a report that may be presented on the dashboard. In an example, information stored in a database or in a memory of a mobile device may be accessed on a period basis or at a specified time of day to develop a report for a dashboard. In another example, information in a database or stored in a memory may be accessed as the information changes to develop an up to date report for the dashboard, which may be delivered or announced as a push notification on the mobile device, for example.

In various examples, the saving system and methods described above may be applied to saving money indirectly by saving other resources, such as electricity, water, fuel, or time. In some examples, the methods may be applied to simply saving the resource itself.

Each of the examples described in this document are non-limiting examples. Each of the non-limiting examples may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. A method comprising:
at an electronic device with one or more input devices and a display device:
presenting a user interface on the display device, the user interface displaying an invitation to participate in a first and a second challenge, the first challenge a challenge corresponding to days of the week in which a user of the electronic device does not work and involving a first resource-saving behavior that avoids or reduces at least one first expense, and the second challenge a challenge corresponding to days of the week in which the user works and involving a second resource-saving behavior that avoids or reduces at least one second expense;
receiving, via the one or more input devices, an acceptance of the invitation through the user interface of the electronic device;
determining, a time based upon the first resource-saving behavior and based upon a current time, location of the user, activity of the user, and user profile information;
delivering, at the determined time, a prompt to a user on the electronic device to assist the user in achieving the first and second resource-saving behavior;
automatically determining, using sensors of the electronic device, that a user has achieved the first resource-saving behavior within a first time period based upon detecting that the user avoided a physical location related to achievement of the first resource-saving behavior during the first time period, the first time period corresponding to a day of the week in which the user is not working;
responsive to automatically determining that the user has achieved the first resource-saving behavior, automatically initiating a predefined financial transaction associated with the first challenge, the predefined financial transaction comprising a transfer of funds from a first financial account of the user to a second financial account of the user;
analyzing a series of physical locations determined by the sensors of the electronic device to determine patterns of motion, the series of physical locations sampled within a second time period that corresponds to a day of the week in which the user is working;
determining that the patterns of motion are indicative of walking or biking that matches the second resource-saving behavior, the patterns of motion comprising a plurality of geographic locations and an indication of user velocity;
responsive to determining that the patterns of motion are indicative of a mode of transportation that matches the second resource-saving behavior, automatically determining that a user has achieved the second resource-saving behavior within the second time period; and
responsive to automatically determining that the user has achieved the second resource-saving behavior, automatically initiating a second predefined financial transaction associated with the second challenge, the second predefined financial transaction comprising a second transfer of funds from the first financial account of the user to the second financial account of the user.

2. The method of claim 1, further comprising
automatically determining that the user has achieved the first resource-saving behavior within a third time period based upon detecting that the user avoided the physical location related to the achievement of the first resource-saving behavior during the third time period; and
responsive to automatically determining that the user has achieved the first resource-saving behavior within the third time period, automatically initiating a third predefined transaction associated with the challenge.

3. The method of claim 1, wherein presenting the invitation includes presenting a plurality of challenges, including the first and second challenges, and receiving the acceptance of the invitation includes receiving a selection of the first challenge and the second challenge of the plurality of challenges.

4. The method of claim 1, wherein the predefined transaction is a transfer of an amount of funds saved as a result of the achievement of the first resource-saving behavior.

5. The method of claim 1, wherein the second challenge comprises a third resource saving behavior that comprises not eating at a restaurant and wherein the method prompt comprises providing a reminder to a user to make a meal prior to work, the determined time a night before the second time period.

6. (canceled)

7. The method of claim 1, wherein presenting the user interface includes presenting the first challenge to engage in the first resource-saving behavior during a challenge period that includes the first time period and a plurality of additional time periods.

8. The method of claim 7, wherein the challenge period includes a specified number of days, the first time period being a day and the plurality of additional time periods being a plurality of additional days.

9. The method of claim 8, wherein a savings amount is specified by the user on a daily basis.

10. (canceled)

11. The method of claim 1, further comprising displaying on the user interface of the electronic device a dashboard that indicates whether the first and second resource-saving behaviors have been achieved in the first time period and on each of a plurality of additional time periods.

12. (canceled)

13. (canceled)

14. A system comprising:
a hardware processor;
a memory storing instructions that, when executed by the hardware processor, cause the hardware processor to perform operations comprising:
presenting on a user interface of a mobile electronic device an invitation to participate in a first and a second challenge, the first challenge a challenge corresponding to days of the week in which a user of the mobile electronic device does not work and involving a first resource-saving behavior that avoids or reduces at least one first expense and the second challenge a challenge corresponding to days of the week in which the user works and involving a second resource-saving behavior that avoids or reduces at least one second expense;
receiving an acceptance of the invitation through the user interface of the mobile electronic device;
determining, a time based upon the first resource-saving behavior and based upon a current time, location of the user, activity of the user, and user profile information;
delivering, at the determined time, a prompt to a user on the electronic device to assist the user in achieving the first and second resource-saving behavior;
automatically determining, using sensors of the electronic device, that a user has achieved the first resource-saving behavior within a first time period based upon detecting that the user avoided a physical location related to achievement of the first resource-saving behavior during the first time period, the first time period corresponding to a day of the week in which the user is not working;
responsive to automatically determining that the user has achieved the first resource-saving behavior, automatically initiating a predefined financial transaction associated with the first challenge, the predefined financial transaction comprising a transfer of funds from a first financial account of the user to a second financial account of the user;
analyzing a series of physical locations determined by the sensors of the electronic device to determine patterns of motion, the series of physical locations sampled within a second time period that corresponds to a day of the week in which the user is working;
determining that the patterns of motion are indicative of walking or biking that matches the second resource-saving behavior, the patterns of motion comprising a plurality of geographic locations and an indication of user velocity;
responsive to determining that the patterns of motion are indicative of a mode of transportation that matches the second resource-saving behavior, automatically determining that a user has achieved the second resource-saving behavior within the second time period; and
responsive to automatically determining that the user has achieved the second resource-saving behavior, automatically initiating a second predefined financial transaction associated with the second challenge, the second predefined financial transaction comprising a second transfer of funds from the first financial account of the user to the second financial account of the user.

15. The system of claim 14, wherein the operations further comprise:
automatically determining that the user has achieved the first resource-saving behavior within a third time period based upon detecting that the user avoided the physical location related to the achievement of the first resource-saving behavior during the third time period; and
responsive to automatically determining that the user has achieved the first resource-saving behavior within the third time period, automatically initiating a third predefined transaction associated with the challenge.

16. The system of claim 14, wherein the operations further comprise fetching from the memory, first information identifying the first challenge and second information identifying a status of a user's participation in the first challenge.

17. (canceled)

18. A non-transitory computer-readable storage medium including instructions that when executed by a mobile electronic device, cause the mobile electronic device to perform operations of:
presenting on a user interface of a mobile electronic device an invitation to participate in a first and a second challenge, the first challenge a challenge corresponding to days of the week in which a user of the mobile electronic device does not work and involving a first resource-saving behavior that avoids or reduces at least one first expense and the second challenge a challenge corresponding to days of the week in which the user works and involving a second resource-saving behavior that avoids or reduces at least one second expense;
receiving an acceptance of the invitation through the user interface of the mobile electronic device;
determining, a time based upon the first resource-saving behavior and based upon a current time, location of the user, activity of the user, and user profile information;
delivering, at the determined time, a prompt to a user on the electronic device to assist the user in achieving the first and second resource-saving behavior;
automatically determining, using sensors of the electronic device, that a user has achieved the first resource-saving behavior within a first time period based upon detecting that the user avoided a physical location related to achievement of the first resource-saving behavior during the first time period, the first time period corresponding to a day of the week in which the user is not working;
responsive to automatically determining that the user has achieved the first resource-saving behavior, automatically initiating a predefined financial transaction associated with the first challenge, the predefined financial transaction comprising a transfer of funds from a first financial account of the user to a second financial account of the user;
analyzing a series of physical locations determined by the sensors of the electronic device to determine patterns of motion, the series of physical locations sampled within a second time period that corresponds to a day of the week in which the user is working;
determining that the patterns of motion are indicative of walking or biking that matches the second resource-saving behavior, the patterns of motion comprising a plurality of geographic locations and an indication of user velocity;
responsive to determining that the patterns of motion are indicative of a mode of transportation that matches the second resource-saving behavior, automatically determining that a user has achieved the second resource-saving behavior within the second time period; and
responsive to automatically determining that the user has achieved the second resource-saving behavior, automatically initiating a second predefined financial transaction associated with the second challenge, the second predefined financial transaction comprising a second transfer of funds from the first financial account of the user to the second financial account of the user.

19. The non-transitory computer-readable storage medium of claim 18, wherein the second challenge is a transportation challenge and wherein the
mode of transportation is a mass transit mode of transportation.

20. (canceled)
